(19) United States
(12) Patent Application Publication
(10) Pub. No.: US 2026/0251149 A1
(43) Pub. Date: Aug. 27, 2026

(54) Submersible Semi-Axial Centrifugal Pump and Impeller for Such Pump

(71) Applicant: Xylem Europe GmbH, Schaffhausen (CH)

(72) Inventors: Viktor Bredwad, Spånga (SE); Fredrik Söderlund, Stockholm (SE); Tobias Pilstrand, Stockholm (SE)

(21) Appl. No.: 19/413,027

(22) Filed: Dec. 9, 2025

(30) Foreign Application Priority Data
Dec. 10, 2024 (EP) 24218556.9

(51) Int. Cl. F04D 29/18; F04D 1/02

(52) U.S. Cl. CPC F04D 29/183; F04D 1/025

(57) ABSTRACT

The invention relates to a submersible semi-axial centrifugal pump for installation in a column, and includes an outer pump housing and an inner pump core arrangement. The pump core arrangement includes a drive unit, a semi-axial open centrifugal impeller and a plurality of guide vanes extending between and connecting the pump housing and the drive unit, wherein the impeller includes a hub and at least two spirally swept blades, wherein the hub is essentially cone-shaped tapering towards the inlet of the pump housing. Each blade includes a leading edge, a trailing edge and a lower edge. The leading edge of each blade is swept backwards from an inner end located at the hub towards an outer end located at the inner surface of the pump housing, wherein a centre axis of the impeller is located at a relative radius R* equal to 0 and the outer end of the leading edge of each blade of the impeller is located at a relative radius R* equal to 1, and wherein a sweep angle of the leading edge is in the range 32-45 degrees at a first relative radius R*1 equal to 0,5, and in the range 47-60 degrees at a second relative radius R*2 equal to 0,95, and is continuously increasing from the first relative radius R*1 to the second relative radius R*2.

### CROSS-REFERENCE TO RELATED APPLICATION

This application claims priority to European Patent Application No. 24218556.9 filed Dec. 10, 2024, the disclosure of which is hereby incorporated by reference in its entirety.

### BACKGROUND OF THE INVENTION

### Field of the Invention

The present invention relates generally to the field of submersible semi-axial centrifugal pumps that are configured for pumping liquid comprising solid/fibrous matter. A submersible semi-axial centrifugal pump is normally used to transport large amounts of screened sewage/wastewater, stormwater, drainage water, etc., a rather limited height, e.g. about 2000 litre/second about 20 meters during rated/nominal operational speed. A submersible semi-axial centrifugal pump is normally arranged lowered into a rigid column extending from a first/lower basin/volume to a second/upper basin/volume.

In particular, the present invention relates to a submersible semi-axial centrifugal pump for installation in a column and configured for pumping liquid comprising solid matter. Wherein the pump comprises:
an outer pump housing having an axial inlet and an axial outlet, and
an inner pump core arrangement, comprising:
   a stationary drive unit surrounded at least partly by the pump housing,
   a semi-axial open centrifugal impeller that is suspended from the drive unit and located adjacent the inlet of the pump housing, and
   a plurality of guide vanes extending between and connecting the pump housing and the drive unit of the pump core arrangement,
wherein the impeller comprises a hub and at least two spirally swept blades connected to the hub and extending in the radial direction from the hub, wherein the hub is essentially cone-shaped tapering towards the inlet of the pump housing, each blade comprising a leading edge facing the inlet of the pump housing, a trailing edge facing the outlet of the pump housing and a lower edge, wherein the lower edge extends from the leading edge to the trailing edge and wherein the lower edge is located adjacent an inner surface of the pump housing.

The present invention also relates to a semi-axial open centrifugal impeller suitable for a semi-axial centrifugal pump according to the above.

### Description of Related Art

In some types of liquid handling, for instance transport of large volumes of contaminated water comprising solid matter, i.e. sewage/wastewater, stormwater, drainage water, etc., a submersible semi-axial centrifugal pump presents a number of advantages in relation to conventional axial propeller pumps which are usually intended for clean water or lightly contaminated water.

Conventional semi-axial centrifugal pumps are designed to have the advantages of a centrifugal pump in terms of efficiency and pressure and the ability to pump contaminated water, while at the same time allowing a discharge flow in the axial direction like an axial propeller pump. Thus, the pump is designed to guide the liquid in an outward spiral in a mixture of radial/axial direction from the impeller towards the pump housing in order to increase the pressure by centrifugal action and thereafter guide vanes are used to redirect the liquid flow from rotating to axial in order to recover static pressure to the liquid flow leaving the pump housing. The inlet of the semi-axial centrifugal pump and the outlet of the pump are facing in the axial direction. Such semi-axial centrifugal pumps may also be called mixed-flow pumps.

Semi-axial centrifugal pumps are arranged lowered into a column and are typically installed downstream screens and are thus protected from fibrous matter, wet wipes, textiles, facemasks, etc., that are prone to clog the pump and impeller by clinging to the leading edges of the impeller. Conventional semi-axial centrifugal pumps comprise either closed impellers or open impellers having straight leading edges, wherein the impellers are designed/optimized for pumping performance only. Thus, conventional semi-axial centrifugal pumps have no immediate risk of becoming clogged since the worst solid matter is removed before the liquid reaches the pump, and the pumps may thereby be designed/optimized for pumping performance only. However, when using different screens upstream the pump in order to prevent solid matter from reaching the pump, these screens must be cleaned at regular intervals, which is a cumbersome and hard work.

Thus, the is a need in the present technical field for a semi-axial centrifugal pump configured to pump unscreened liquid comprising fibrous solid matter, such as wet wipes, textiles, facemasks, etc.

### SUMMARY OF THE INVENTION

The present invention aims at obviating the aforementioned disadvantages and failings of previously known semi-axial centrifugal pumps and semi-axial open centrifugal impellers, and at providing an improved semi-axial centrifugal pump and an improved semi-axial open centrifugal impeller.

A primary object of the present invention is to provide an improved semi-axial centrifugal pump and an improved semi-axial open centrifugal impeller, configured to pump unscreened liquid comprising fibrous solid matter. It is another object of the invention to provide an improved semi-axial centrifugal pump and an improved semi-axial open centrifugal impeller, wherein the solid matter is guided outwards in the radial/tangential direction of the inlet of the pump, without having prominent negative effect on the pumping performance.

According to the invention at least the primary object is attained by means of the initially defined pump and impeller having the features described herein. Preferred embodiments of the present invention are further defined herein.

According to the present invention, the leading edge of each blade of the impeller is swept backwards from an inner end located at the hub towards an outer end located at the inner surface of the pump housing, and the outer end of the leading edge is located upstream the inner end of the leading edge,
wherein a centre axis (A) of the impeller is located at a relative radius R* equal to 0 and the outer end of the leading edge of each blade of the impeller is located at a relative radius R* equal to 1, and
wherein a sweep angle (α) of the leading edge is in the range 32-45 degrees at a first relative radius R*1 equal to 0,5, and in the range 47-60 degrees at a second relative radius R*2 equal to 0,95, and is continuously increasing from the first relative radius R*1 to the second relative radius R*2,
wherein the sweep angle (α) at any given relative radius R* of the leading edge () is located in a first geometrical plane (P1) defined by:
   a first vector (V1) that is tangent to a mean line of the blade at the given relative radius R* of the leading edge, and
   a second vector (V2) that is tangent to the leading edge at the given relative radius R* of the leading edge, and
wherein the sweep angle (α) is defined between:
   the first vector (V1) that is tangent to the mean line of the blade at the given relative radius R* of the leading edge, and
   a third vector (V3) that is normal to the leading edge at the given relative radius R* of the leading edge.

Thus, the present invention is based on the insight that when designing the leading edge of the impeller based on optimal values of the sweep angle (α) along the leading edge of the impeller, a self-cleaning effect of the impeller/pump is accomplished without involving negative effect on the pumped flow (pumping performance). The sweep angle (α) shall increase continuously from the first relative radius R*1 to the second relative radius R*2, but the increase does not have to be linear and the increase is preferably slightly accelerating in the outwards direction. Having the outer end of the leading edge located upstream the inner end of the leading edge, the extension of the pressure side of the blade of the impeller adjacent the leading edge may be designed in a more optimal way that promotes the pumping performance of the pump.

According to various embodiments of the present invention, the sweep angle (α) of the leading edge is in the range 32-40 degrees at the first relative radius R*1 equal to 0,5, and in the range 47-55 degrees at a second relative radius R*2 equal to 0,95, and is continuously increasing from the first relative radius R*1 to the second relative radius R*2. By decreasing the upper limits of the sweep angle (α) at first relative radius R*1 and at the second relative radius R*2, respectively, any negative effect on the pumping performance is also decreased. The lower limits of the sweep angle (α) at first relative radius R*1 and at the second relative radius R*2, are unchanged since it is found that these provides an adequate self-cleaning of the leading edges of the impeller over a wide range of operational speeds, i.e. rpm of the pump.

According to various embodiments of the present invention, the inner end of the leading edge of each blade of the impeller is located at a third relative radius R*3 in the range 0,25-0,45.

Having the inner end of the leading edge closer to the centre axis (A) of the impeller, entails that the liquid flow at the inner part of the leading edge decrease and self-cleaning effect close to the top of the hub decrease. Thus, the top of the hub of the impeller shall preferably have a minimum diameter, such that fibrous solid matter does not get entangled about the hub of the impeller. Having the inner end of the leading edge too far away from the centre axis (A), entails that the risk of having wipes, textile cloths, etc. getting stuck over the top of the hub increase. Thus, the top of the hub of the impeller shall preferably have a maximum diameter.

According to various embodiments of the present invention, a partial sector angle (Θ-part) of the leading edge projected onto a transversal plane (P2) of the pump is taken between:
a first line extending from the centre axis (A) of the impeller to the intersection between the leading edge and the first relative radius R*1, and
a second line extending from the centre axis (A) of the impeller to the intersection between the leading edge and the second relative radius R*2,
   wherein said partial sector angle (Θ-part) is in the range 25-55 degrees.

Having a too small partial sector angle (Θ-part) entails that the self-cleaning effect of the impeller is jeopardized and the inclination/tilt angle of the leading edge of the impeller increases such that the inner end of the leading edge of the impeller is located upstream the outer end of the leading edge of the impeller. Having a too big partial sector angle (Θ-part) entails that width between adjacent blades of the impeller decreases and the risk of clogging increase.

According to various embodiments of the present invention, a tilt angle (β) of the leading edge is located in an axial plane (P3) that is parallel to the centre axis (A) of the impeller, and wherein the tilt angle (β) is defined between:
a tilt line extending between the inner end of the leading edge and the outer end of the leading edge, and
a transversal plane (P2) of the pump,
   wherein the tilt angle (β) is in the range 0-35 degrees, and wherein the outer end of the leading edge is located upstream the inner end of the leading edge.

Having the outer end of the leading edge located upstream the inner end of the leading edge, the extension of the pressure side of the blade of the impeller adjacent the leading edge may be designed in a more optimal way that promotes the pumping performance of the pump.

Further advantages with and features of the invention will be apparent from the following detailed description of preferred embodiments.

### BRIEF DESCRIPTION OF THE DRAWINGS

The terms Fig., Figs., Figure, and Figures are used interchangeably in the specification to refer to the corresponding figures in the drawings.

A more complete understanding of the abovementioned and other features and advantages of the present invention will be apparent from the following detailed description of preferred embodiments in conjunction with the appended drawings, wherein:

FIG. 1 is a schematic perspective view from above of a semi-axial centrifugal pump,

FIG. 2 is a schematic cross-sectional side view of a pump station comprising a semi-axial centrifugal pump according to FIG. 1,

FIG. 3 is a schematic cross-sectional side view of a part of the semi-axial centrifugal pump according to FIG. 1,

FIG. 4 is a schematic perspective cross-sectional view from below of a part of the semi-axial centrifugal pump,

FIG. 5 is a schematic perspective view from below of the hydraulic unit of the semi-axial centrifugal pump according to FIG. 1,

FIG. 6 is a schematic view from above of the semi-axial centrifugal pump according to FIG. 1,

FIG. 7 is a schematic illustration of the leading edge portion of the blade of the impeller,

FIG. 8 is a schematic illustration of the leading edges of the impeller seen from below, and

FIG. 9 is a schematic graph representing the sweep angle at different relative radius for an example impeller, and also illustrating the sweep angle intervals at the first and second relative radius.

### DESCRIPTION OF THE INVENTION

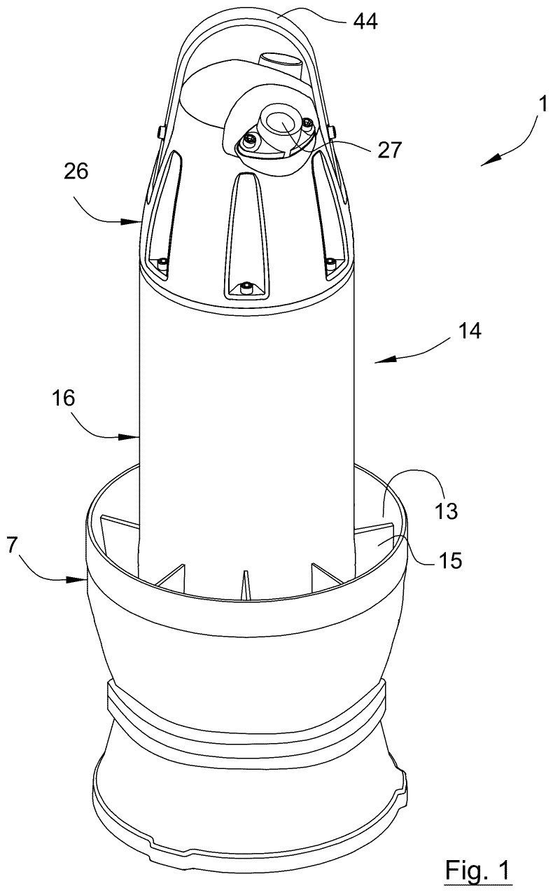

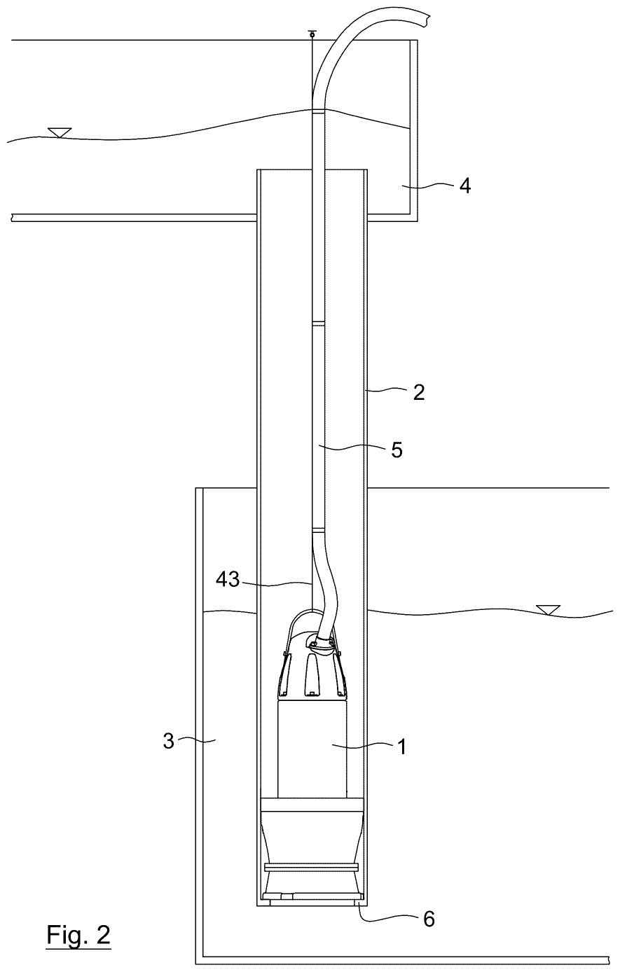

Reference is initially made to FIGS. 1 and 2. The present invention relates generally to a submersible semi-axial centrifugal pump, generally designated 1, that is configured for pumping liquid comprising solid/fibrous matter, such as sewage/wastewater, stormwater, drainage water, etc. Semi-axial centrifugal pumps 1 are generally arranged to transport large amounts of liquid a rather limited height, e.g., e.g. about 2000 litre/second about 20 meters during rated/nominal operational speed. The semi-axial pump 1 according to the present invention is designed to have a specific speed [n_{q}] that is in the range 80-160, preferably in the range 100-120. The specific speed [n_{q}] is determined as [n_{q}=n*Q^{(1/2)}/H^{(3/4)}], wherein n=the nominal rotational speed of the propeller pump (rpm), Q =the pumped liquid flow (m2/sec), and H=the pressure head of the pumped liquid (m).

In FIG. 1 a perspective view from above of a semi-axial pump 1 according to the invention is disclosed, and FIG. 2 disclose a part of a schematic pump station that comprises one or more semi-axial pumps 1, each pump 1 being arranged at a lower end of a column 2. According to the disclosed embodiment, the column 2 extends from a lower basin 3 to an upper basin 4, with the purpose of transporting liquid from the lower basin 3 to the upper basin 4. It should be pointed out that the axial length of the column 2 usually is several times greater than the axial height of the pump 1, and that the pump 1 and the column 2 are concentrically arranged in relation to each other. The pump 1 is connected to one or more cables 5 for the power supply and possible signal transfer, which cables 5 run from the pump 1, via the inside of the column 2, up to a power source and/or to a control unit (not shown).

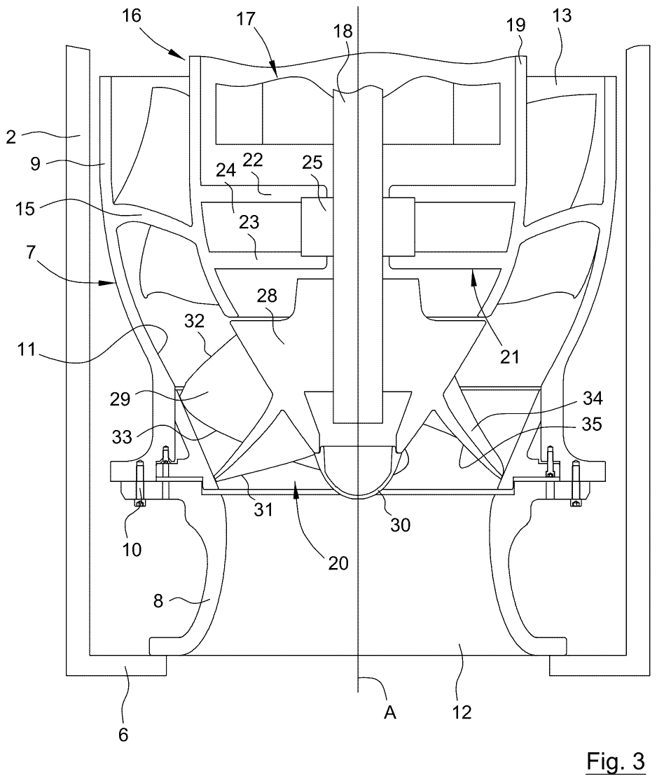

Reference is now also made to FIG. 3, disclosing a schematic cross-sectional side view of the lower part of the semi-axial centrifugal pump 1 and of the lower end of the column 2, i.e. parts of the pump 1 and the column 2 are removed. Thus, the pump 1 is normally intended to be placed in a column 2 that is partly lowered into the pumped media. During installation, the semi-axial centrifugal pump 1 is lowered into the column 2 until it stands on a bottom flange 6 in the column 2 and thereby seals tightly against the column 2. Consequently, the pump 1 is entirely or partly submersed into the media when it has reached its operational position. During operation, the column 2 also works as an outlet pipe for the pumped liquid. Before any service to the pump 1, the pump 1 is hoisted and removed from the column 2.

The inventive semi-axial centrifugal pump 1 comprises an axially extending outer pump housing, generally designated 7. The outer pump housing 7 is essentially tubular, and comprises in the disclosed embodiment an inlet funnel 8 and a diffuser 9, which are interconnected in an axial interrelationship. According to various embodiments, the inlet funnel 8 and the diffuser 9 are fixedly connected to each other by means of a plurality of axially extending connection screws 10. Thus, the inlet funnel 8 may be detached from the diffuser 9 by loosening the connection screws 10, but when the pump 1 is assembled the inlet funnel 8 and the diffuser 9 are in direct and fixed contact with each other. Thus, the pump 1 has always the same height. The pump housing 7 has an inner surface 11 and comprises furthermore an axial inlet opening 12 situated at the region of the lower/upstream end of the inlet funnel 8 and an axial outlet opening 13 situated at the region of the upper/downstream end of the diffuser 9. Thus the inner surface 11 of the pump housing 7 extends from the inlet 12 to the outlet 13. The pump 1 is arranged to be lowered down into the column 2, and thereby the pump 1 has a somewhat smaller outer diameter than an inner diameter of the column 2. Thereby, a gap arises between an external surface of the pump housing 7 and an inner surface of the column 2. In order to prevent reflow of the pumped liquid down through said gap, i.e. via the space situated between the inner surface of the column 2 and an outer surface of the pump housing 7, the pump housing 7 rests on and closes tightly against the radially inwardly extending bottom flange 6 arranged at the lower end of the column 2. Said space between the column 2 and the pump 1 may be filled with water and solids without having negative effect on the operation of the pump 1. According to various embodiments the lower surface of the pump 1 is abutting the flange 6. However, other flanges of the pump 1 may serve as abutment surface, such as the flange at the interface between the diffuser 9 and the inlet funnel 8.

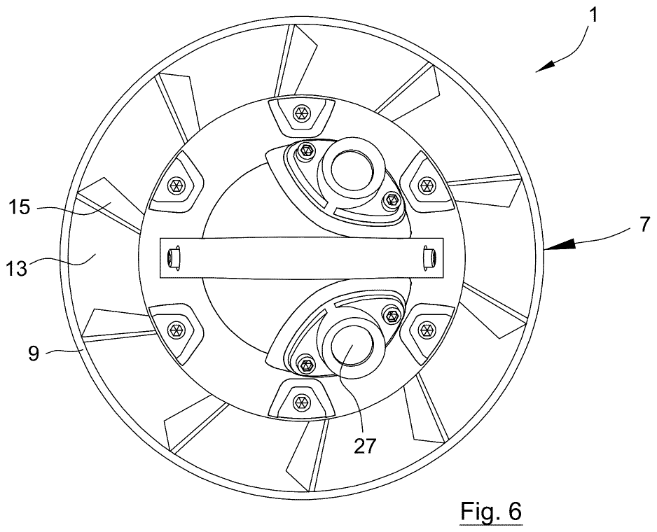

Furthermore, the semi-axial centrifugal pump 1 according to the invention comprises an axially extending inner pump core arrangement, generally designated 14. The lower part of the pump core arrangement 14 is surrounded by the pump housing 7, i.e. by the diffuser 9, and the upper part of the pump core arrangement 14 is surrounded by the column 2 when the pump 1 is in the mounted state in the column 2. Thus, the pump core arrangement 14 has an axial height that is greater than the axial height of the pump housing 7. Preferably, the axial height of the pump core arrangement 14 is at least twice as large as the axial height of the pump housing 7. In other words, the pump housing 7 and the pump core arrangement 14 are arranged overlapping each other in the axial direction, at the same time as the pump core arrangement 14, in the radial direction, is situated at a distance from the inner surface 11 of the pump housing 7. Preferably, the pump core arrangement 14 and the pump housing 7 are concentrically arranged in relation to each other. In addition, the pump 1 according to the invention comprises a plurality of radially extending guide vanes 15, which are connected to the inner surface 11 of the pump housing 7 and to the envelope surface of the pump core arrangement 14. Preferably, the pump 1 comprises ten or more such guide vanes 15, which are equidistantly arranged along the circumference of the pump core arrangement 14. Reference is also made to FIG. 6, which disclose a view from above of a pump 1 according to the invention.

The inner pump core arrangement 14 comprises a drive unit, generally designated 16, which comprises an electric motor 17 and a drive shaft 18 extending from said motor in the axial direction. The motor 17 is directly or indirectly connected to the power supply cable 5, which extends from an external power supply. Preferably, the drive unit 16 comprises an axially extending tubular motor housing 19. The guide vanes 15 extend between the motor housing 19 of the drive unit 16 and the pump housing 7. Furthermore, the pump core arrangement 14 comprises semi-axial open centrifugal impeller 20 that is suspended from the drive unit 16, i.e. from the lower end of the drive shaft 18. The impeller 20 is located adjacent the inlet 12 of the pump housing 7. The impeller 20 is located radially inside the diffuser 9.

The pump core arrangement 14 further comprises a liquid seal unit 21 configured to separate the volume that houses the impeller 20 and the liquid tight motor compartment that houses the motor 17 from each other in a liquid tight manner, i.e. in order to protect the motor 17 from the pumped liquid. The liquid seal unit 21 is surrounded by the motor housing 19, an upper wall 22 that is called oil housing cover and a lower wall 23 that is called oil housing bottom, which together define a chamber 24 accommodating a liquid, preferably an oil. The liquid seal unit 21 forms a seat for a drive shaft sealing assembly 25, also known as sealing cartridge, which is schematically disclosed and which comprises an outer mechanical face seal that prevents the pumped liquid from leaking into the chamber 24 and an inner mechanical face seal that prevents the liquid in the chamber 24 from leaking into the motor compartment. Instead of said mechanical face seals, the drive shaft sealing assembly 25 may comprise other types of suitable seals, and alternatively the liquid seal unit 21 may comprise other type of sealing solution than said drive shaft sealing assembly.

Furthermore, in the shown embodiment, the pump core arrangement 14 comprises a pump top, generally designated 26, in which internal power supply to the motor 17 and external power supply via the power supply cable 5 are interconnected. The pump top 26 comprises liquid tight lead-through 27 receiving the electric power cable 5. Preferably, the pump top 26 has a truncated conical shape in order to minimize the emergence of regions having a rearwardly directed/negative flow rate in the column 2 directly downstream the pump top 26.

According to various embodiments, the pump 1, more precisely the electric motor 17, is operatively connected to a control unit, such as an Intelligent Drive comprising a Variable Frequency Drive (VFD). Thus, said pump 1 is configured to be operated at a variable operational speed [rpm], by means of said control unit. According to various embodiments, the control unit is located in an electronics chamber of the pump top 26, i.e. it is preferred that the control unit is integrated into the pump 1. The pump top 26, i.e. the electronics/connection chamber, is separated from the motor compartment in a liquid tight manner. The control unit is configured to control the operational speed of the pump 1. According to alternative embodiments the control unit is an external control unit, or the control unit is divided into an external sub-unit and an internal sub-unit. The operational speed of the pump 1 is more precisely the rpm of the electric motor 17 and of the impeller 20 and corresponds to the output frequency of the control unit.

The components of the pump 1 are cold down by means of the liquid/water surrounding the pump 1.

The semi-axial open centrifugal impeller 20 comprises a hub 28 and at least two spirally swept blades/vanes 29 that are connected to and extends in the radial direction from said hub 28. Said hub 28 is essentially cone-shaped and tapering in the direction towards the inlet 12 of the pump housing 7. The envelope surface of the hub 28, at the downstream end of the impeller 20, is aligned with the envelope surface of the motor housing 19 of the drive unit 16. At the upstream end of the impeller 20, the hub 28 comprises a spherical top 30 free from blades 29. The spherical hub top 30 is preferably removable in order to gain access to the drive shaft 18, i.e. in order to connect the impeller 20 to the lower end of the drive shaft 18 in a conventional way, for instance by means of a screw arrangement.

Each blade 29 comprises a leading edge 31 facing the inlet 12 of the pump housing 7, a trailing edge 32 facing the outlet 13 of the pump housing 7 and a lower edge 33, wherein the lower edge 33 extends from the leading edge 31 to the trailing edge 32 and wherein the lower edge 33 is located adjacent the inner surface 11 of the pump housing 7. The lower edge 33 separates a pressure side 34 of the blade 29 and a suction side 35 of the blade 29 from each other.

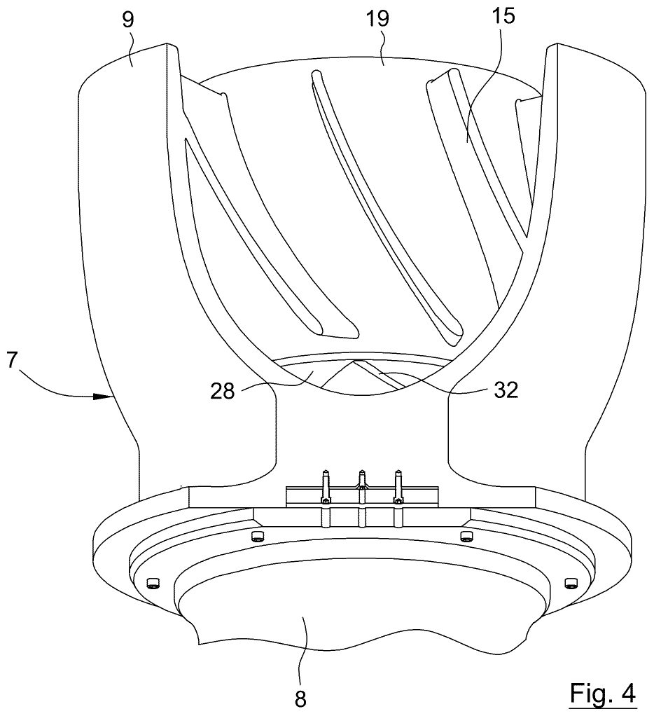

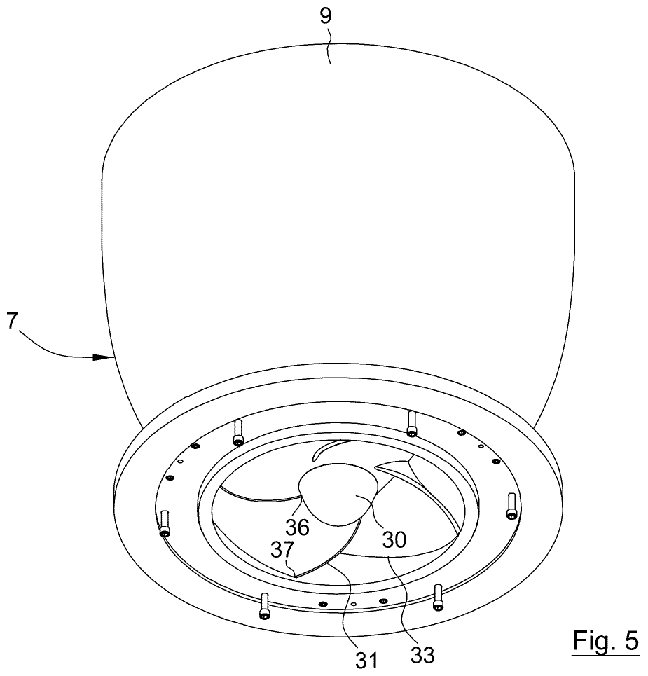

Each blade 29 extends toward the inner surface 11 of the pump housing 7, and a narrow gap separates said blades 29 and the inner surface 11 of the pump housing 7. Said gap is preferably equal to or more than 0,05 mm and equal to or less than 2 mm. Preferably, the impeller 20 comprises three or four blades 29, which are equidistantly arranged along the circumference of the hub 28. Reference is also made to FIGS. 4 and 5, which disclose the diffuser 9 and wherein the inlet funnel 8 is removed for sake of clarity. The blades 29 are spirally swept from the leading edge 31 to the trailing edge 32, i.e. in a direction opposite the direction of rotation of the impeller 20 during normal (liquid pumping) operation of the pump 1.

According to the invention, the leading edge 31 of each blade 29 of the impeller 20 is swept backwards from an inner end 36 located at the hub 28 towards an outer end 37 located at the inner surface 11 of the pump housing 7. A centre axis (A) of the impeller 20 is located at a relative radius R* equal to 0 and the outer end 37 of the leading edge 31 of each blade 29 of the impeller 20 is located at a relative radius R* equal to 1. The leading edge 31 has a sweep angle (α) that defines the design/configuration of the upstream end region of the blades 29, and may be said being a measure of the trade-off between pumping performance and self-cleaning. The present invention is focusing on designing the leading edge 31 of the blades 29 such that any solid matter that is caught over the leading edge 31 is automatically guided/transported outwards towards the outer end 37 of the leading edge 31. The rotational speed at the outer end 37 of the leading edge 31 is greater than the rotational speed at the inner end 36 of the leading edge 31, and thereby it is much more likely that the solid matter will slide off the leading edge 31 when guided outwards.

The inventors has identified that the optimum self-cleaning function is accomplished when the sweep angle (α) of the leading edge 31 is in the range 32-45 degrees at a first relative radius R*1 equal to 0,5, and in the range 47-60 degrees at a second relative radius R*2 equal to 0,95, and is continuously increasing from the first relative radius R*1 to the second relative radius R*2.

Thus, at the first relative radius R*1 the sweep angle (α) is equal to or more than 32 degrees and equal to or less than 45 degrees. A smaller sweep angle (α) at the first relative radius R*1 entails that the self-cleaning of the leading edge 31 will become unsatisfactory and the risk that the impeller becomes soft-clogged is increased, i.e. the solid matter will stick to the leading edge 31, and a too big sweep angle (α) at the first relative radius R*1 entails that the negative effect on the pumping performance is too high. Preferably, the sweep angle (α) at the first relative radius R*1 is equal to or less than 40 degrees. Thereby, any negative effect on the pumping performance is further decreased.

Thereto, at the second relative radius R*2 the sweep angle (α) is equal to or more than 47 degrees and equal to or less than 60 degrees. A smaller sweep angle (α) at the second relative radius R*2 entails that the self-cleaning of the leading edge 31 will become unsatisfactory and the risk that the impeller becomes soft-clogged is increased, i.e. the solid matter will stick to the leading edge 31, and a too big sweep angle (α) at the second relative radius R*2 entails that the negative effect on the pumping performance is too high. Preferably, the sweep angle (α) at second relative radius R*2 is equal to or less than 55 degrees. Thereby, any negative effect on the pumping performance is further decreased.

The first relative radius R*1 is equal to 0,5 since the design/configuration of the leading edge 31 closer to the hub 28 has little or negligible effect, and the actual shape of the leading edge 31 radially inside the first relative radius R*1 is more dependent on having a smooth transition to the hub 28. The second relative radius R*2 is equal to 0.95 since the design/configuration of the leading edge 31 at the outer end 37 of the leading edge 31 is based on having a smooth transition to the lower edge 33 of the leading edge 31.

The inner end 36 of the leading edge 31 of each blade 29 of the impeller 20 is located at a third relative radius R*3 that is equal to or more than 0,25 and equal to or less than 0,45, preferably equal to or less than 0,35. A smaller value of the third relative radius R*3 entails that the attachment of the impeller 20 to the drive shaft 18 is made more complicated and having the leading edge 31 extended further inwards will have limited or negligible effect on the overall pumping performance. A larger value of the third relative radius R*3 entails that the top of the hub 28 risk to become too large and increased risk of having solid matter caught over the top of the hub 28.

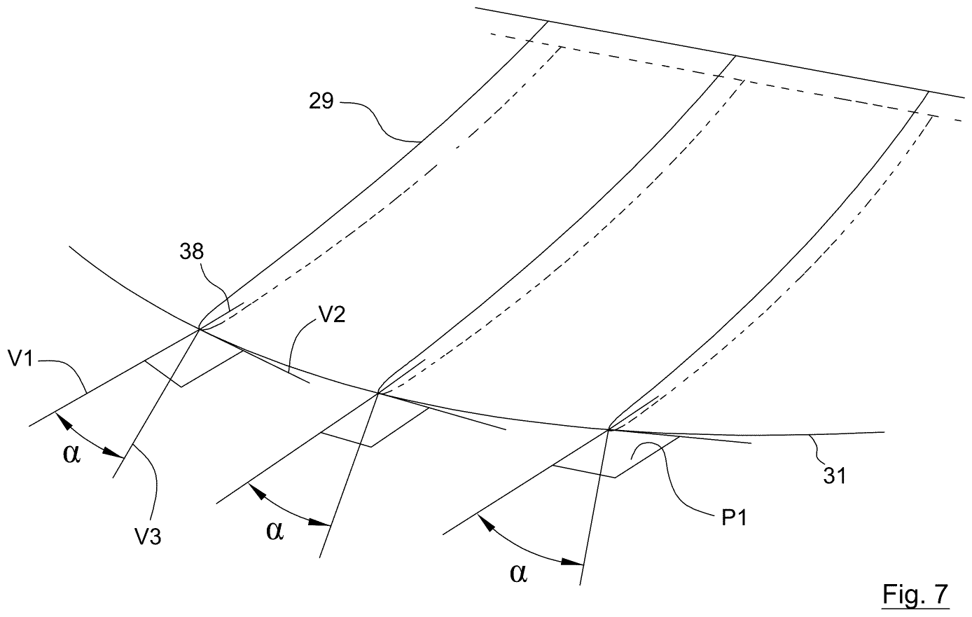

Reference is now especially made to FIG. 7, disclosing a schematic illustration of the leading edge 31 of the blade 29 of the impeller 20. Only a portion of the blade 29 is disclosed, and the blade 29 is illustrated as being partly transparent.

The sweep angle (α) at any given relative radius R* of the leading edge 31, i.e. within the limits of the relative radius R* discussed above, is located/measured in a first geometrical plane (P1). The extension of the first geometrical plane P1 is distinctive for each given relative radius R*, and is defined by:
a first vector (V1) that is tangent to a mean line 38 of the blade 29 at the given relative radius R* of the leading edge 31, and
a second vector (V2) that is tangent to the leading edge 31 at the given relative radius R* of the leading edge 31.

The first vector (V1) represents a theoretical optimal flow vector when observed locally at the region of the leading edge 31 of the blade, and V1 is parallel to the flow path direction.

The mean line 38 of the blade 29 is the middle of the blade 29, seen between the pressure side 34 and the suction side 35 of the blade 29, and the first vector V1 that is tangent to the mean line 38, i.e. a prolongation of the mean line 38, illustrates the design/configuration of the leading edge 31 seen in the flow path direction. The second vector V2 that is tangent to the leading edge 31, illustrates the design/configuration of the leading edge 31 seen transversal to the flow path direction. Thus, a mean line 38 of the blade extends from the leading edge 31 to the trailing edge 32, and the ratio between the distance from the mean line 38 to the envelope surface of the hub 28 and the distance from the mean line 38 to the inner surface 11 of the pump housing 7 is constant.

The sweep angle (α) is located in said first geometrical plane (P1) and is defined/measured between:
the first vector (V1) that is tangent to the mean line 38 of the blade 29 at the given relative radius R* of the leading edge 31, and
a third vector (V3) that is normal to the leading edge 31 at the given relative radius R* of the leading edge 31.

The third vector (V3) represents the normal to the leading edge 31 when observed locally at the leading edge 31 of the blade, and the deviation from the optimal first vector (V1) is defined by the sweep angle (α). Thus, the deviation between the third vector (V3) and the optimal first vector (V1) provides a radial force acting on and transporting the solid matter radially outwards along the leading edge 31.

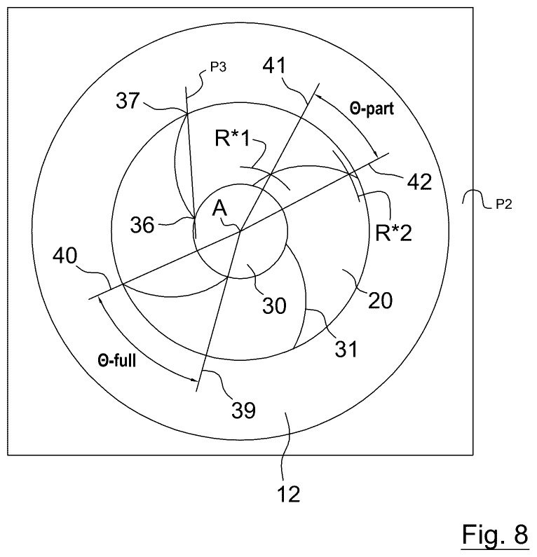

Reference is now made to FIG. 8, disclosing a schematic illustration of the leading edges 31 of the impeller 20 seen from below via the inlet 12 of the pump 1. The disclosed impeller 20 comprises four blades 29. According to various embodiments, the leading edge 31 is swept backwards from the inner end 36 to the outer end 37, which may be defined/measured by projecting the leading edge 31 onto a transversal plane (P2) of the pump 1. A full sector angle (Θ-full) of the leading edge 31 projected onto the transversal plane (P2) of the pump 1 is taken between:
an inner end line 39 extending from the centre axis (A) of the impeller 20 to the inner end 36 of the leading edge 31, and
an outer end line 40 extending from the centre axis (A) of the impeller 20 to the outer end 37 of the leading edge 31,
   wherein said full sector angle (Θ-full) is in the range 30-70 degrees.

Having a smaller full sector angle (Θ-full) entails that the self-cleaning effect of the impeller 20 is jeopardized and the inclination/tilt angle of the leading edge 31 of the impeller 20 needs to be increased such that the inner end 36 of the leading edge 31 of the impeller 20 is located upstream the outer end 37 of the leading edge 31 of the impeller 20. Having a larger full sector angle (Θ-full) entails that width between adjacent blades 29 of the impeller 20 decreases and the risk of clogging increase.

According to various embodiments, a partial sector angle (Θ-part) of the leading edge 31 projected onto the transversal plane (P2) of the pump 1 is taken between:
a first line 41 extending from the centre axis (A) of the impeller 20 to the intersection between the leading edge 31 and the first relative radius R*1, and
a second line 42 extending from the centre axis (A) of the impeller 20 to the intersection between the leading edge 31 and the second relative radius R*2,
   wherein said partial sector angle (Θ-part) is in the range 25-55 degrees.

Having a smaller partial sector angle (Θ-part) entails that the self-cleaning effect of the impeller 20 is jeopardized and the inclination/tilt angle of the leading edge 31 of the impeller 20 needs to be increased such that the inner end 36 of the leading edge 31 of the impeller 20 is located upstream the outer end 37 of the leading edge 31 of the impeller 20. Having a larger partial sector angle (Θ-part) entails that width between adjacent blades 29 of the impeller 20 decreases and the risk of clogging increase.

According to various embodiments of the present invention, the leading edge 31 has an inclination/tilt in the axial direction, i.e. a tilt angle (β). The tilt angle (β) of the leading edge 31 is located in an axial plane (P3) that is parallel to the centre axis (A) of the impeller 20. Said axial plane (P3) usually do not comprise the centre axis (A). The tilt angle (β) is defined between:
a tilt line extending between the inner end 36 of the leading edge 31 and the outer end 37 of the leading edge 31, and
the transversal plane (P2) of the pump 1,
   wherein the tilt angle (β) is in the range 0-35 degrees, and wherein the outer end 37 of the leading edge 31 is located upstream the inner end 36 of the leading edge 31.

It shall be pointed out that the tilt angle (β) in some embodiments may be negative, i.e. in the range −15-0 degrees, wherein the outer end 37 of the leading edge 31 is located downstream the inner end 36 of the leading edge 31.

According to the various embodiments of the present invention, reference to FIGS. 1-2, a wire 43, is connected to a lifting handle 44, which in turn is connected with the pump top 26. Via the inside of the column 2, the wire 43 is running up to a fixing point situated above the column 2, preferably, the extension of the wire 43 coincides with an extension of the centre line of the pump 1. Furthermore, the at least one power supply cable 5 of the pump 1 leaves the pump top 26 and is then attached to the wire 43 and runs along the wire 43 up to a level above the column 2. The object of attaching the power supply cable 5 to the wire 43 is that a free-hanging power supply cable will be influenced by a rotary component of velocity in the liquid flow in the column 2, and thereby risk being turned around and worn into pieces against the inner surface of the column 2.

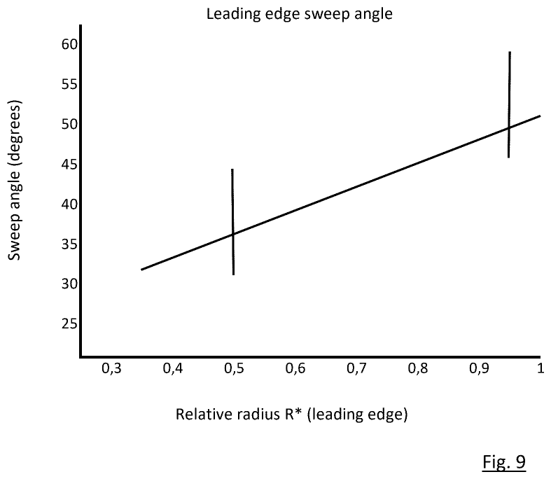

Reference is now made to FIG. 9, that discloses a schematic graph representing the sweep angle (α) at different relative radius R* for an example impeller, and also disclosing the sweep angle (α) intervals at the first relative radius R*1 and at the second relative radius R*2, respectively.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims. Any subject matter falling outside the scope of the claims is provided for information purposes and for placing the invention into a relevant context.

It shall also be pointed out that all information about/concerning terms such as above, under, upper, lower, etc., shall be interpreted/read having the equipment oriented according to the figures, having the drawings oriented such that the references can be properly read. Thus, such terms only indicate mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1. A submersible semi-axial centrifugal pump for installation in a column and configured for pumping liquid comprising solid matter, comprising:
an outer pump housing having an axial inlet opening and an axial outlet opening, and
an inner pump core arrangement, comprising:
a drive unit surrounded at least partly by the pump housing,
a semi-axial open centrifugal impeller that is suspended from the drive unit and located adjacent the inlet of the pump housing, and
a plurality of guide vanes extending between and connecting the pump housing and the drive unit of the pump core arrangement,
wherein the impeller comprises a hub and at least two spirally swept blades connected to the hub and extending in the radial direction from the hub, wherein the hub is essentially cone-shaped tapering towards the inlet of the pump housing, each blade comprising a leading edge facing the inlet of the pump housing, a trailing edge facing the outlet of the pump housing and a lower edge, wherein the lower edge extends from the leading edge to the trailing edge and wherein the lower edge is located adjacent an inner surface of the pump housing,
wherein the leading edge of each blade of the impeller is swept backwards from an inner end located at the hub towards an outer end located at the inner surface of the pump housing, and the outer end of the leading edge is located upstream the inner end of the leading edge,
wherein a centre axis of the impeller is located at a relative radius R* equal to 0 and the outer end of the leading edge of each blade of the impeller is located at a relative radius R* equal to 1,
wherein a sweep angle of the leading edge is in the range 32-45 degrees at a first relative radius R*1 equal to 0,5, and in the range 47-60 degrees at a second relative radius R*2 equal to 0,95, and is continuously increasing from the first relative radius R*1 to the second relative radius R*2,
wherein the sweep angle at any given relative radius R* of the leading edge is located in a first geometrical plane defined by:
a first vector that is tangent to a mean line of the blade at the given relative radius R* of the leading edge, and
a second vector that is tangent to the leading edge at the given relative radius R* of the leading edge, and
wherein the sweep angle is defined between:
the first vector that is tangent to the mean line of the blade at the given relative radius R* of the leading edge, and
a third vector that is normal to the leading edge at the given relative radius R* of the leading edge.

2. The submersible semi-axial centrifugal pump according to claim 1, wherein the sweep angle of the leading edge is in the range 32-40 degrees at the first relative radius R*1 equal to 0,5, and in the range 47-55 degrees at a second relative radius R*2 equal to 0,95, and is continuously increasing from the first relative radius R*1 to the second relative radius R*2.

3. The submersible semi-axial centrifugal pump according to claim 1, wherein the inner end of the leading edge of each blade of the impeller is located at a third relative radius R*3 in the range 0,25-0,45, preferably in the range 0,25-0,35.

4. The submersible semi-axial centrifugal pump according to claim 1, wherein a partial sector angle of the leading edge projected onto a transversal plane of the pump is taken between:
a first line extending from the centre axis of the impeller to the intersection between the leading edge and the first relative radius R*1, and
a second line extending from the centre axis of the impeller to the intersection between the leading edge and the second relative radius R*2,
wherein said partial sector angle is in the range 25 - 55 degrees.

5. The submersible semi-axial centrifugal pump according to claim 1, wherein a full sector angle of the leading edge projected onto a transversal plane of the pump is taken between:
an inner end line extending from the centre axis of the impeller to the inner end of the leading edge, and
an outer end line extending from the centre axis of the impeller to the outer end of the leading edge,
wherein said full sector angle is in the range 30-70 degrees.

6. The submersible semi-axial centrifugal pump according to claim 1, wherein a tilt
angle of the leading edge is located in an axial plane that is parallel to the centre axis of the impeller, and wherein the tilt angle is defined between:
a tilt line extending between the inner end of the leading edge and the outer end of the leading edge, and
a transversal plane of the pump,
wherein the tilt angle is in the range 0-35 degrees, and wherein the outer end of the leading edge is located upstream the inner end of the leading edge.

7. A semi-axial open centrifugal impeller for a submersible semi-axial centrifugal pump according to claim 1, wherein the impeller comprises a hub and at least two spirally swept blades connected to the hub and extending in the radial direction from the hub, wherein the hub is essentially cone-shaped tapering towards an inlet of the pump housing, each blade comprising a leading edge facing the inlet of the pump housing, a trailing edge facing an outlet of the pump housing and a lower edge, wherein the lower edge extends from the leading edge to the trailing edge (32) and wherein the lower edge (33) is located adjacent an inner surface of the pump housing,
wherein the leading edge of each blade of the impeller is swept backwards from an inner end located at the hub towards an outer end located at the inner surface of the pump housing, and the outer end of the leading edge is located upstream the inner end of the leading edge,
wherein a centre axis of the impeller is located at a relative radius R* equal to 0 and the outer end of the leading edge of each blade of the impeller is located at a relative radius R* equal to 1,
wherein a sweep angle of the leading edge is in the range 32-45 degrees at a first relative radius R*1 equal to 0,5, and in the range 47-60 degrees at a second relative radius R*2 equal to 0,95, and is continuously increasing from the first relative radius R*1 to the second relative radius R*2,
wherein the sweep angle at any given relative radius R* of the leading edge is located in a first geometrical plane defined by:
a first vector that is tangent to a mean line of the blade at the given relative radius R* of the leading edge, and
a second vector that is tangent to the leading edge at the given relative radius R* of the leading edge, and
wherein the sweep angle is defined between:
the first vector that is tangent to the mean line of the blade at the given relative radius R* of the leading edge, and
a third vector that is normal to the leading edge at the given relative radius R* of the leading edge.
